(19) United States
(12) Patent Application Publication
(10) Pub. No.: US 2019/0334165 A1
(43) Pub. Date: Oct. 31, 2019

(54) NEGATIVE ELECTRODE STRUCTURE FOR SECONDARY BATTERY AND SECONDARY BATTERY INCORPORATING SAME

(71) Applicant: MURATA MANUFACTURING CO., LTD., Kyoto (JP)

(72) Inventors: Sun HUAYU, Kyoto (JP); Li YULI, Kyoto (JP)

(21) Appl. No.: 16/396,163

(22) Filed: Apr. 26, 2019

(30) Foreign Application Priority Data
Apr. 28, 2018 (CN) 201810403159.6

(51) Int. Cl. H01M 4/36; H01M 4/62; H01M 4/38; H01M 10/052

(52) U.S. Cl. CPC H01M 4/366; H01M 4/628; H01M 2004/027; H01M 10/052; H01M 4/382

(57) ABSTRACT

The present disclosure provides a negative electrode structure for a secondary battery having both good battery performances and a sufficiently low thermal runaway risk in good balance, and a secondary battery using this negative electrode structure. The negative electrode structure is a prelithiated negative electrode structure, and includes a negative electrode mixture layer including a negative electrode active material, a buffer layer and a lithium layer. The buffer layer is configured to partially cover the negative electrode mixture layer.

### CROSS REFERENCE TO RELATED APPLICATIONS

The present application claims priority to Chinese Patent Application No. 201810403159.6 filed on Apr. 28, 2018, the entire contents of which are being incorporated herein by reference.

### BACKGROUND

The present disclosure generally relates to a negative electrode structure for a secondary battery and a secondary battery incorporating this negative electrode structure, particularly to a pre-lithiated negative electrode structure having both superior battery properties and a sufficiently low thermal runaway risk in good balance, and a secondary battery incorporating this negative electrode structure.

Along with the increasing growth of the market of portable electronic devices such as mobile phones, notebook computers, digital cameras and the like, secondary batteries having a large energy density and a long service life are desired as cordless power supplies of these electronic devices. To meet such requirements, secondary batteries using alkali metal ions such as lithium ions and the like as charge carriers and utilizing electrochemical reactions involving donation and acceptance of the charges are under development. Particularly, lithium ion secondary batteries have been widely available nowadays.

In the abovementioned lithium ion secondary batteries, lithium-containing transition metal oxides are generally used as positive electrode active materials, and carbon based negative electrode materials such as graphite, Si based negative electrode materials, Sn based alloy negative electrode materials and the like are used as negative electrode active materials. Charge and discharge are effected by intercalation and deintercalation reactions of lithium ions with these electrode active materials.

Nowadays, as lithium ion secondary batteries are used more and more widely, an increasingly higher energy density is required. However, when a conventional negative electrode active material is used, the negative electrode material reacts with a lithium-containing electrolyte at a solid-liquid phase interface during the first charge and discharge process to form a layer of solid electrolyte interface film (SEI film for short). Since the formation of this SEI film consumes a portion of the lithium ions, the irreversible capacity of the first charge and discharge increases, and in turn, the initial efficiency of the secondary battery decreases. Therefore, it's desired to further increase the initial efficiency of the lithium ion secondary battery.

In order to address the challenges of reducing lithium ion consumption in the first charge and discharge process and increasing the initial efficiency of a negative electrode like a graphite or Si based negative electrode, extensive research and development efforts have been devoted in recent years to prelithiation technologies, such as vacuum evaporation of lithium, or rolling and adhesion of a lithium foil to a negative electrode material. For example, formation of a lithium foil on a negative electrode by rolling lithium powder (e.g. SLMP available from FMC Corporation) or a lithium strip is regarded as a prelithiation technology having outstanding advantages in safety and mass productivity.

Nonetheless, in the existing prelithiation technologies, the lithium layer that is rolled/adhered to a negative electrode material is in direct contact with the negative electrode active material like the abovementioned carbon material (such as graphite) and the Si based material, or a Sn based alloy material, etc, and undergoes violent reaction to form LiCx, LiSix, LiMex, etc. A large quantity of heat may be generated extremely rapidly during the formation of these compounds. Particularly, in the courses of manufacturing a prelithiated electrode, subsequently rolling it for storage, and filling an electrolyte to form a secondary battery product, more heat tends to be generated and accumulated, even leading to a risk of various thermal runaways such as fire and explosion, etc. With an aim to reduce this risk, temperature (<10° C.) and humidity (<1-2%) are usually required to be strictly controlled in production, storage and rolling of prelithiated electrodes, electrolyte filling, and shaping, among other technological processes, resulting in an increased risk and issues of thermal runaways and fire in production, a tedious production process, an increased production cost, and poorer mass productivity.

### SUMMARY

The present disclosure generally relates to a negative electrode structure for a secondary battery and a secondary battery incorporating this negative electrode structure, particularly to a pre-lithiated negative electrode structure having both superior battery properties and a sufficiently low thermal runaway risk in good balance, and a secondary battery incorporating this negative electrode structure.

In view of the above problems, an object of the present disclosure is to develop a negative electrode structure for a secondary battery having both good battery performances and a sufficiently low thermal runaway risk in good balance, and a secondary battery using this negative electrode structure.

According to an embodiment of the present disclosure, a negative electrode structure for a secondary battery is provided. The negative electrode structure includes a negative electrode mixture layer including a negative electrode active material, a buffer layer and a lithium layer, wherein the buffer layer is configured to partially cover the negative electrode mixture layer. The negative electrode structure is a prelithiated negative electrode structure, and includes the negative electrode mixture layer, the buffer layer and the lithium layer in this order.

According to an embodiment of the present disclosure, a method of manufacturing a negative electrode structure for a secondary battery is provided. The negative electrode structure includes in order a negative electrode mixture layer including a negative electrode active material, a buffer layer and a lithium layer; wherein the manufacturing method comprises: a process step of forming a negative electrode mixture layer including a negative electrode active material; a process step of forming a buffer layer on the negative electrode mixture layer; and a process step of forming a lithium layer on the buffer layer, and wherein in the process step of forming the buffer layer, the buffer layer is configured to partially cover the negative electrode mixture layer.

According to an embodiment of the present disclosure, a secondary battery is provided. The second battery includes a positive electrode, a negative electrode, a separator and an electrolyte, wherein the negative electrode includes a negative electrode structure according to embodiments of the present disclosure as described herein, or the negative electrode structure manufactured by the method of manufacturing a negative electrode structure as described herein.

In the negative electrode structure for a secondary battery according to the present disclosure, since the buffer layer does not completely cover the negative electrode mixture layer, the metal lithium still contacts the negative electrode active material to some extent, thereby decreasing the internal resistance of the battery, and improving various battery performances such as energy density, electrode porosity, electrolyte retainability, rate performance, cycling performance, and the like. On the other hand, due to the limited extent of contact between the metal lithium and the negative electrode active material, heat generation will not be too rapid, such that the risk of various thermal runaways such as fire, explosion and the like is low. Hence, the negative electrode structure for a secondary battery according to the present disclosure is able to have both good battery performances and a sufficiently low thermal runaway risk in good balance, and thus exhibits excellent mass productivity, particularly useful for technological processes which are demanding in terms of a low thermal runaway risk, such as production, storage and rolling of prelithiated electrodes, electrolyte filling, shaping, etc.

In addition, as the secondary battery of the present disclosure uses the negative electrode structure for a secondary battery according to the present disclosure, the secondary battery demonstrates improved capability of good battery performances and a sufficiently low thermal runaway risk as well as excellent mass productivity.

The advantageous effects mentioned in the present description are for illustrative purpose only and are not limited to the above-mentioned effects, and other suitable properties relating to the present technology may be realized and as further described.

### BRIEF DESCRIPTION OF THE FIGURES

Now, the disclosure will be further illustrated with reference to the following accompanying drawings in which:

FIG. 1 is a section view schematically showing an embodiment of the negative electrode structure for a secondary battery according to the present disclosure.

FIG. 2 is a top view schematically showing an embodiment of the buffer layer in the negative electrode structure for a secondary battery according to the present disclosure.

FIG. 3 is a top view schematically showing another embodiment of the buffer layer in the negative electrode structure for a secondary battery according to the present disclosure.

FIG. 4 is a top view schematically showing a buffer layer in a comparative negative electrode structure for a secondary battery.

FIG. 5 is a section view schematically showing an embodiment of the secondary battery according to the present disclosure, together with a partial enlarged detail view thereof.

FIG. 6 is a graph showing the test results of the performances of the negative electrode structures for a secondary battery in the examples according to the present disclosure.

### DETAILED DESCRIPTION

As described herein, the present disclosure will be described based on examples with reference to the drawings, but the present disclosure is not to be considered limited to the examples, and various numerical values and materials in the examples are considered by way of example.

The negative electrode structure for a secondary battery according to the present disclosure is a prelithiated negative electrode structure, comprising in order a negative electrode mixture layer comprising a negative electrode active material, a buffer layer and a lithium layer, wherein the buffer layer covers the negative electrode mixture layer incompletely. The negative electrode structure for a secondary battery has both good battery performances and a sufficiently low thermal runaway risk in good balance, quite useful in a negative electrode for a secondary battery.

As used herein, “prelithiation” of a negative electrode structure means a process of providing an additional lithium source (such as the abovementioned lithium layer) to a negative electrode, so that lithium ions from this additional lithium source are consumed in the formation of an SEI film and the lithium doping of the negative electrode, and the consumption of lithium ions deintercalated from a positive electrode is minimized, thereby improving the initial efficiency of the negative electrode, the energy density and the cycling performance. Hence, when reference is made to a “prelithiated negative electrode structure”, it includes not only a negative electrode structure in which a lithium layer is formed on a negative electrode mixture layer while lithium ions are not doped into the negative electrode mixture layer, but also a negative electrode structure in which lithium doping has already been accomplished by the abovementioned prelithiation process.

It's contemplated that the capability of having both good battery performances and a sufficiently low thermal runaway risk in the present disclosure may be attributed to the following reasons.

In the conventional prelithiation technologies, the lithium layer that is rolled/adhered to a negative electrode material is in direct contact with the negative electrode active material like a carbon material (such as graphite), a Si based material, a Sn based alloy material, etc, and undergoes violent reaction to form LiCx, LiSix, LiMex, etc. In contrast, in the negative electrode structure for a secondary battery according to the present disclosure, the existence of the buffer layer between the lithium layer and the negative electrode mixture layer can reduce direct contact between the metal lithium and the negative electrode active material, and violent reaction is thus less likely to take place, thereby preventing thermal runaway caused by huge heat that would otherwise be generated in such violent reaction. On the other hand, since the buffer layer does not completely cover the negative electrode mixture layer, the metal lithium still contacts the negative electrode active material to some extent, thereby avoiding problems of increase in the internal resistance of the battery and decrease in the energy density, and enhancing the rate performance of the battery.

For the above reasons, in some embodiments, to have the buffer layer cover the negative electrode mixture layer incompletely, an area ratio of an area of the buffer layer to an area of the negative electrode mixture layer or the lithium lithium (the area of the buffer layer/the area of the negative electrode mixture layer or the lithium lithium) is set at 5-95%. If the area ratio is less than 5%, the function of inhibiting violent reaction between the metal lithium and the negative electrode active material may not work, leading to an increased thermal runaway risk. On the contrary, if the area ratio is greater than 95%, there will be nearly no direct contact between the metal lithium and the negative electrode active material, which may result in problems of increase in the internal resistance of the battery, decrease in the energy density, degradation of the rate performance, deterioration of the cycling performance, etc. Additionally, as compared with the prior art in which a complete buffer layer is formed, the amount of the buffer layer forming material may be reduced by setting the area ratio in the above range, thereby reducing cost and improving mass productivity. The area ratio is preferably 15-80%, more preferably 20-50%, still more preferably 20-30%.

As used herein, an expression like “5-95%” is intended to include each and every specific value in the numerical range. For example, when “5-95%” is used to describe the above area ratio, the area ratios that are included may be 5%, 10%, 15%, 20%, 25%, 30%, 35%, 40%, 45%, 50%, 55%, 60%, 65%, 70%, 75%, 80%, 85%, 90%, 95%, etc. When such a numerical range is used for description hereafter, it's used in the same sense.

In order that the area ratio of the buffer layer falls in the above numerical range, the buffer layer may be formed into one or more shapes selected from various continuous or noncontinuous, symmetric or asymmetric, regular or irregular, uniform or nonuniform shapes (topological structures). For example, in some embodiments, as a buffer layer having a noncontinuous shape, the buffer layer may be formed as islands. In some other embodiments, as a buffer layer having a noncontinuous shape, the buffer layer may be formed as stripes. As used herein, so-called island and stripe both refer to the shape and distribution of various parts that corporately constitute the buffer layer. The shapes of the various parts may be symmetric or asymmetric, regular or irregular, and the distribution of the various parts may be uniform or nonuniform. In addition, the shapes of the various parts may be identical or different. For example, in some embodiments, when the buffer layer is in the form of islands, the shape of some of the islands may be different from the shape of other islands.

As a method of forming the above buffer layer, a method that can be used to form a buffer layer having a desired shape (e.g. the above island or stripe) is applicable, and any method known in the art may be used without limitation with the proviso that the effect of the present disclosure is not negatively affected. For example, in some embodiments, a buffer layer may be formed by coating a buffer layer slurry comprising a buffer layer forming material as will be described hereafter, a binder as will be described hereafter and a dispersing medium as will be described hereafter on a surface of a negative electrode mixture layer in a desired shape (e.g. island or stripe), followed by drying. In particular, for example, exemplary coating methods may be selected without limitation from the group consisting of spin coating, wire-bar coating, slot die coating, gravure coating, and screen printing.

As a buffer layer forming material for forming a buffer layer, a material that can prevent direct contact between the metal lithium and the negative electrode active material is applicable, and any material that is commonly used in the art may be used without limitation with the proviso that the effect of the present disclosure is not negatively affected. In particular, for example, inorganic ceramic materials, solid electrolyte micropowders, water-borne PVdF, flame resistant conductive polymers, gel electrolytes, electrolyte soluble organics, and carbon nanomaterials may be exemplified without limitation.

As the above inorganic ceramic materials, Al₂O₃ (e.g. boehmite particles, alumina powder, etc), AlF₃ powder, MgO, magnesium hydroxide, TiOx (e.g. rutile, anatase, etc) may be exemplified; as the above solid electrolyte micropowders, solid electrolyte micropowders of perovskite type, NASICON type, LISICON type, garnet type and the like may be exemplified; as the above water-borne PVdF which means PVdF that possesses hydrophilicity by way of hydrophilization treatment and is dispersible in water, the Water-borne PVDF Latex family commercially available from Arkema Corporation may be exemplified; as the above flame resistant conductive polymers, polyaniline, polypyrrole, polythiophene and the like may be exemplified; as the above gel electrolytes, PVdF-HEP and the like may be exemplified; as the above electrolyte soluble organics, polysiloxane, ethylene carbonate and the like may be exemplified; as the above carbon nanomaterials, soft carbon, hard carbon, acetylene black, Ketjen black, graphite black, carbon nanotubes and the like may be exemplified. However, the examples listed above are only exemplary, and the buffer layer forming materials useful in the present disclosure are not limited thereto. These materials may be used alone or in a combination of two or more of them.

In addition, in some embodiments, besides the abovementioned buffer layer forming material, a binder is preferably used when the above buffer layer is formed, for the purpose of adhering these materials securely. As the binder, the binders that are commonly used in the art may be exemplified, for example, polysaccharides such as starch, polyvinyl alcohol, carboxymethyl cellulose, hydroxypropyl cellulose, regenerated cellulose, diacetyl cellulose, etc; resin materials such as polytetrafluoroethylene, polyvinylidene difluoride (PVdF), polyhexafluoropropylene, polyethylene, polypropylene, polyvinyl chloride, aramid resins, polyimide, polyamide-imide, polyacrylic acid, polymethyl acrylate, ethylene-acrylic acid copolymer, polyacrylonitrile, polyvinyl acetate, polyvinyl pyrrolidone, polyether sulfone, etc; rubber like materials such as styrene butadiene rubber (SBR), butadiene rubber, ethylene-propylene-diene terpolymer (EPDM), fluoro rubber, etc. These binders may be used alone or in a combination of two or more of them. The binder is used in an amount of, for example, 0.5-10 mass parts, preferably 1-5 mass parts based on a total of 100 mass parts of the buffer layer.

The above dispersing medium is not particularly limited, and can be selected at will in light of, inter alia, the required performances and mass productivity of the buffer layer. For example, water, alcohols such as methanol and ethanol, ethers such as tetrahydrofuran, ketones such as acetone, nitriles such as acetonitrile, amides such as dimethyl formamide, esters such as propylene carbonate, diethyl carbonate, dimethyl carbonate and γ-butyrolactone, N-methyl-2-pyrrolidone (NMP), and mixed solvents thereof may be exemplified.

The thickness of the formed buffer layer is not particularly limited, with 0.1-5 μm being preferred. Here, in the case that a buffer layer is formed in a noncontinuous shape such as island or stripe, the thickness of the buffer layer refers to an average of the thicknesses of, for example, the various “islands” or “stripes” of the buffer layer.

The formed buffer layer may have porosity. When the porosity of the buffer layer is described in terms of pore size, the pore size of the buffer layer is preferably in the range of from 100 nm to 2.5 μm, and may be regulated as desired using various processes.

In some embodiments, the negative electrode mixture layer of the disclosure is a layer comprising a negative electrode active material. As a negative electrode active material, any material that is commonly used in the art may be used without limitation so long as it's a material that is commonly used in the art to carry out a prelithiation technology, with the proviso that the effect of the present disclosure is not negatively affected. Carbon negative electrode materials, Si based negative electrode materials, Sn based alloy negative electrode materials and the like may be exemplified.

As a carbon negative electrode material used as a negative electrode active material, a variety of carbon materials capable of reversibly absorbing/desorbing lithium may be used with no limitation to their types. In particular, for example, graphite, graphitizable carbon (soft carbon), non-graphitizable carbon (hard carbon) and the like may be exemplified. Graphite refers to a material having a graphite type crystal structure, such as natural graphite, artificial graphite, graphitized mesophase carbon particles, etc. The carbon negative electrode materials may be used alone or in a combination of two or more of them. In order to obtain a high capacity, graphite is preferably used as the carbon negative electrode material.

As a Si based negative electrode material used as a negative electrode active material, a Si based negative electrode material that is commonly used in the art may be used. In particular, for example, low dimensional silicon materials such as zero dimensional Si nanoparticles, one dimensional Si nanowires/nanotubes, two dimensional Si nanofilms, etc; Si/O composite materials represented by SiOx; Si/C modified composite materials such as Si/C (amorphous carbon) composite materials, Si/MCMB (mesophase carbon microbeads) composite materials, Si/CNTs (carbon nanotubes) composite materials, Si/GN (graphene) composite materials, graphene/Si/C modified ternary composite materials, etc; Si/metal modified composite materials such as Si/Fe composite materials, Si/Co composite materials, Si/Cu composite materials, Si/Ni composite materials and the like may be exemplified. The Si based negative electrode materials may be used alone or in a combination of two or more of them.

As a Sn based alloy negative electrode material used as a negative electrode active material, a Sn based alloy negative electrode material that is commonly used in the art may be used. In particular, for example, binary or ternary composite materials formed from Sn and a variety of metals or nonmetals may be exemplified. Sn based alloy negative electrode materials that are commonly used include, for example, Sn—Co, Sn—Ni, Sn—Cu, Sn—Sb, Sn—Co—C, Sn—Ni—P, Sn—Co—P, Sn—Sb—Cu, etc. The Sn based alloy negative electrode materials may be used alone or in a combination of two or more of them.

In addition, in some embodiments, besides the abovementioned negative electrode active material, the negative electrode mixture layer may further comprise one or more conventional additives such as binders, conductive agents and/or thickeners as optional components. A negative electrode mixture layer comprising one or more of the above additives may be formed by, for example, coating a negative electrode mixture slurry comprising a negative electrode active material, a binder, a conductive agent and/or a thickener as well as a dispersing medium on a surface of a negative electrode current collector, followed by drying. The dried coating film may be calendered as desired. The negative electrode mixture layer may be formed on one or both surfaces of the negative electrode current collector.

As a binder, the same binders as those exemplified for use in a buffer layer may be exemplified. These binders may be used alone or in a combination of two or more of them. The binder is used in an amount of, for example, 0.5-10 mass parts, preferably 1-5 mass parts based on a total of 100 mass parts of the negative electrode active material.

As a conductive agent, for example, carbonaceous microparticles such as graphite, carbon black, acetylene black and the like; conductive fibers such as carbon fibers (e.g. vapor grown carbon fibers, carbon nanotubes, carbon nanohorns), metal fibers and the like; fluorocarbons; metal powders such as aluminum and the like; conductive crystal whiskers such as zinc oxide, potassium titanate and the like; conductive metal oxides such as titanium oxide and the like; conductive high molecular materials such as polyaniline, polypyrrole, polythiophene, polyacetylene, polyacene and the like may be exemplified. These conductive agents may be used alone or in a combination of two or more of them. The conductive agent is used in an amount of, for example, less than 10 mass parts, preferably 1-5 mass parts based on a total of 100 mass parts of the negative electrode active material.

As a thickener, for example, derivatives (cellulose ethers, etc) of cellulose such as carboxymethyl cellulose (CMC) and modified CMC (including Na salt, etc), methyl cellulose and the like; saponified products of polymers comprising vinyl acetate units such as polyvinyl alcohol; polyethers (polyalkylene oxides such as polyethylene oxide, etc) and the like may be exemplified. These thickeners may be used alone or in a combination of two or more of them. The thickener is used in an amount of 0.1-10 mass parts, preferably 1-5 mass parts based on a total of 100 mass parts of the negative electrode active material.

The dispersing medium is not particularly limited, and can be selected at will in light of, inter alia, the required performances and mass productivity of the negative electrode structure for a secondary battery and the secondary battery. For example, the same dispersing media as those exemplified for use in the buffer layer may be exemplified.

The thickness of the negative electrode mixture layer of the present disclosure is not particularly limited, typically in the range of 10-100 for example.

In addition, as the abovementioned negative electrode current collector, the negative electrode current collectors that are commonly used in the art may be used, for example, nonporous conductive substrates (metal foils, etc), porous conductive substrates (reticulate bodies, network bodies, stamped sheets, etc). As a material for the negative electrode current collector, copper, copper alloys, stainless steel, nickel, nickel alloys, aluminum, aluminum alloys and the like may be exemplified.

The thickness of the above negative electrode current collector is not particularly limited. In light of the balance between the strength and lightweight of the negative electrode, the thickness is preferably 1-50 μm, more preferably 5-20 μm.

In some embodiments, the lithium layer is a layer for predoping lithium, and may be formed using a conventional method in the art. In particular, a lithium layer is generally a layer that is formed by vacuum evaporation of lithium on a negative electrode mixture layer (it's a negative electrode mixture layer having the abovementioned buffer layer formed thereon in the present disclosure), or by rolling/adhering a lithium foil to the negative electrode mixture layer. Owing to the formation of the lithium layer, a local cell may be formed in the negative electrode structure, thereby introducing lithium ions into the negative electrode active material in advance. As such, the initial efficiency of the negative electrode active material, the energy density of the negative electrode, and the cycling performance of the negative electrode can be enhanced.

The thickness of the lithium layer is not particularly limited. In light of the balance of the prelithiation effect and the cost, the thickness is preferably 1-10 μm.

Now, exemplary configurations of the negative electrode structure for a secondary battery according to the present disclosure will be illustrated in detail with reference to the accompanying drawings, but the implementation of the negative electrode structure for a secondary battery according to the present disclosure is not limited thereto. In addition, the sizes of the various parts shown in the drawings are not necessarily drawn in actual scale for the convenience of description. Thus, the elements in the drawings are not limited by their sizes, and not limited by the sizes of the elements relative to each other.

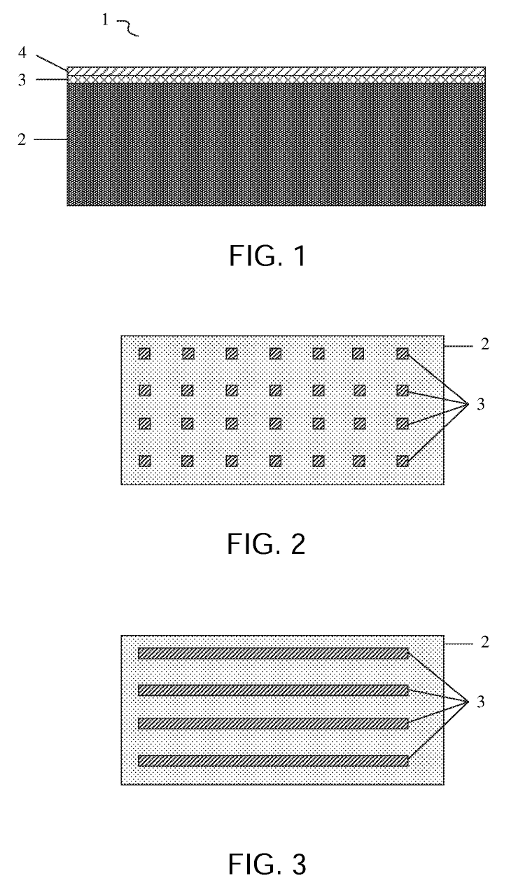

FIG. 1 is a section view schematically showing an embodiment of the negative electrode structure 1 for a secondary battery according to the present disclosure. As shown b FIG. 1, the negative electrode structure 1 for a secondary battery is a prelithiated negative electrode structure, comprising in order a negative electrode mixture layer 2 comprising a negative electrode active material, a buffer layer 3 and a lithium layer 4, wherein the buffer layer 3 covers the negative electrode mixture layer 2 incompletely. The negative electrode structure 1 for a secondary battery has both good battery performances and a sufficiently low thermal runaway risk in good balance, quite useful in a negative electrode for a secondary battery.

FIG. 2 is a top view schematically showing an embodiment of the buffer layer 3 in the negative electrode structure 1 for a secondary battery according to the present disclosure. As shown by FIG. 2, in the present disclosure, the buffer layer 3 may be formed in an island shape. Put in another way, in this embodiment, the buffer layer 3 formed from the buffer layer forming material as described below is not formed continuously, but dispersively. The dispersive “islands” of the buffer layer corporately constitute the buffer layer 3. By forming the buffer layer 3 into a shape of island like this, there is no contact between the metal lithium and the negative electrode active material at locations where the buffer layer is formed, while the metal lithium and the negative electrode active material are in contact at locations where no buffer layer is formed, such that a reasonable degree of contact between the metal lithium and the negative electrode active material can be ensured, thereby providing the negative electrode structure 1 for a secondary battery with both good battery performances and a sufficiently low thermal runaway risk in good balance.

As regards the number of the “islands” of the buffer layer, FIG. 2 shows a case in which 28 islands are formed. However, the number of the islands is not limited thereto. Instead, it may be set at will as desired, so long as it is industrially feasible and can enable the area ratio of the buffer layer 3 to achieve a desired value.

FIG. 3 is a top view schematically showing another embodiment of the buffer layer 3 in the negative electrode structure 1 for a secondary battery according to the present disclosure. As shown by FIG. 3, in the present disclosure, the buffer layer 3 may be formed in a stripe shape. Put in another way, in this embodiment, the buffer layer 3 formed from the buffer layer forming material as described below is not formed continuously, but formed discontinuously into alternating stripes. The “stripes” of the discontinuous buffer layer corporately constitute the buffer layer 3. By forming the buffer layer 3 into a shape of stripe like this, there is no contact between the metal lithium and the negative electrode active material at locations where the buffer layer is formed, while the metal lithium and the negative electrode active material are in contact at locations where no buffer layer is formed, such that a reasonable degree of contact between the metal lithium and the negative electrode active material can be ensured, thereby providing the negative electrode structure 1 for a secondary battery with both good battery performances and a sufficiently low thermal runaway risk in good balance.

As regards the number of the “stripes” of the buffer layer, FIG. 3 shows a case in which 4 stripes are formed. However, the number of the stripes is not limited thereto. Instead, it may be set at will as desired, so long as it is industrially feasible and can enable the area ratio of the buffer layer 3 to achieve a desired value.

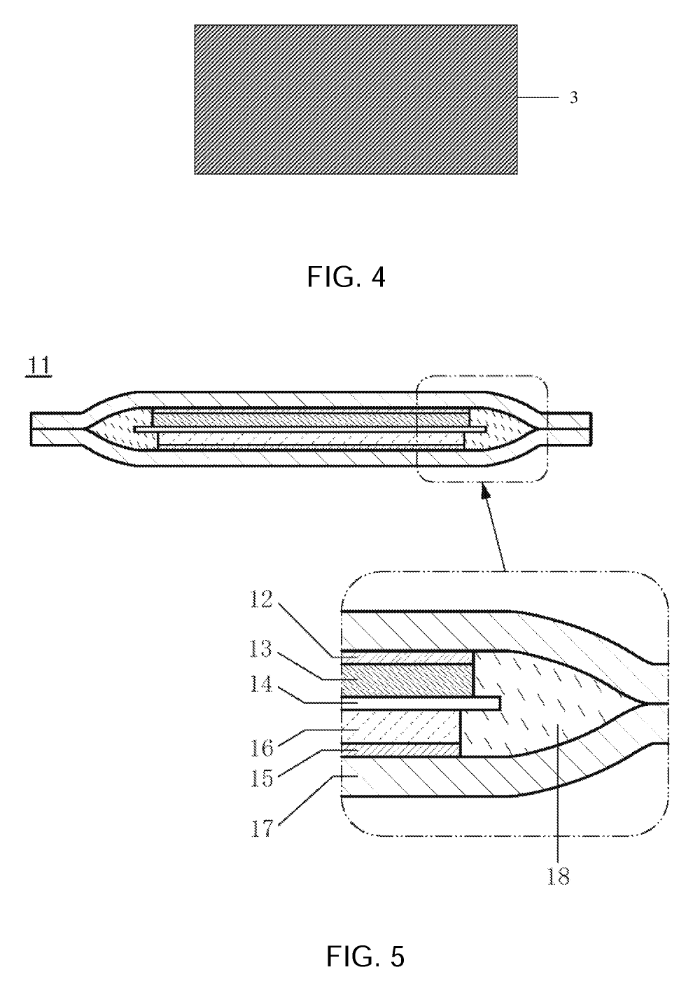

In contrast, FIG. 4 is a top view schematically showing a buffer layer in a comparative negative electrode structure for a secondary battery. In FIG. 4, the buffer layer is formed inextenso between a lithium layer and a negative electrode mixture layer. In other words, the area ratio of the area of the buffer layer to the area of the negative electrode mixture layer or the lithium layer is 100%. Although the use of a buffer layer having such an area ratio as 100% can inhibit the violent reaction between lithium and the negative electrode active material, and thus reduce the thermal runaway risk, problems such as an increased internal resistance of the battery, a decreased energy density, a degraded rate performance, a deteriorated cycling performance and the like will occur due to the poor electric conductivity of the buffer layer. As a result, the requirements of a high energy density and a high rate performance of a lithium secondary battery in practical applications cannot be satisfied.

Now, the secondary battery of the present disclosure will be illustrated in detail with reference to the accompanying drawings, but the implementation of the secondary battery of the present disclosure is not limited thereto.

FIG. 5 is a section view schematically showing an embodiment of the secondary battery 11 according to the present disclosure, together with a partial enlarged detail view thereof. In this embodiment, the secondary battery 11 is a soft package lithium secondary battery. However, the secondary battery of the present disclosure is not limited to a soft package lithium secondary; instead, it can be a typical large-size secondary battery such as a cylindrical lithium secondary battery, a square lithium secondary battery, etc.

In the secondary battery 11 shown in FIG. 5, a positive electrode 13 obtained by forming a positive electrode active material into a sheet shape is arranged on a positive electrode current collector 12. On the other hand, a negative electrode 16 is arranged on a negative electrode current collector 15. Here, the negative electrode structure for a secondary battery according to the present disclosure is used as the negative electrode 16. In addition, a separator 14 is laminated between the positive electrode 13 and the negative electrode 16, and they are contained together in an outer package 17 of battery. The outer package 17 containing the positive electrode 13, the separator 14 and the negative electrode 16 is filled with an electrolyte solution 18. In addition, electrode tabs not shown in the figure are attached to the positive electrode current collector 12 and the negative electrode current collector 15.

The elements other than the negative electrode of the exemplary secondary battery 11 of the present disclosure will be described in more detail, but the description is only exemplary, and these other elements are not particularly limited in the present disclosure.

The positive electrode 13 comprises a positive electrode mixture layer formed or loaded on a surface of the positive electrode current collector 12. In some embodiments, besides the positive electrode active material, the positive electrode mixture layer may further comprise one or more conventional additives such as binders, conductive agents and/or thickeners as optional components. For example, in some embodiments, like the positive electrode 16, the positive electrode 13 may be formed by coating a positive electrode mixture slurry comprising a positive electrode active material, a binder, a conductive agent and/or a thickener as well as a dispersing medium on a surface of the positive electrode current collector 12, followed by drying.

As a positive electrode active material, a lithium-metal oxide composite commonly used in the art, for example, at least one of lithium cobalt oxide (LCO), lithium nickel cobalt manganese oxide ternary material (NCM), lithium nickel cobalt aluminum oxide ternary material (NCA), lithium manganese oxide (LMO), lithium iron phosphate (LFP), lithium-rich positive materials, etc, may be used. Specifically, LiₐCoO₂, LiₐNiO₂, LiₐMnO₂, LiₐCo_{b}Ni_{1-b}O₂, LiₐCo_{b}M_{1-b}O_{c}, LiₐNi_{1-b}M_{b}O_{c}, LiₐMn₂O₄, LiₐMn_{2-b}M_{b}O₄, LiMePO₄, Li₂MePO₄F (M is at least one of Na, Mg, Sc, Y, Mn, Fe, Co, Ni, Cu, Zn, Al, Cr, Pb, Sb, B) may be exemplified, wherein a=0-1.2, b=0-0.9, c=2.0-2.3. It's to be noted that the a value representing the molar ratio of lithium is the value for the as-prepared active material, and varies in the charge and discharge process. Further, a portion of the elements in these lithium-containing compounds may be replaced by other elements. The positive electrode active material may be subjected to surface treatment with a metal oxide, lithium oxide, a conductive agent, and the like. Its surface may also be subjected to hydrophobic treatment.

As the binder, conductive agent, thickener, etc, the same examples as those listed for the negative electrode may be employed.

The thickness of the positive electrode mixture layer is not particularly limited, typically in the range of 10-100 μm, for example.

The binder is used in an amount of 0.5-10 mass parts, preferably 1-5 mass parts based on a total of 100 mass parts of the positive electrode active material. The conductive agent is used in an amount of 0.5-20 mass parts, preferably 1-10 mass parts based on a total of 100 mass parts of the positive electrode active material. The thickener is used in an amount of 0.1-10 mass parts, preferably 1-5 mass parts based on a total of 100 mass parts of the positive electrode active material.

The shape and thickness of the positive electrode current collector 12 may be chosen from the same scopes of the shape and thickness of the negative electrode current collector 15 respectively. As a material for the positive electrode current collector 12, for example, stainless steel, aluminum, aluminum alloy, titanium and the like may be exemplified.

As the separator 14, it is not particularly limited so long as it has high ion permeability, appropriate mechanical strength and insulation property. Microporous films, woven fabrics, non-woven fabrics and the like may be used. As a material for the separator, a known material may be used. In light of endurability, high shut down performance, and easiness to ensure battery safety, polyolefins such as polypropylene, polyethylene and the like are preferred. The microporous film may be a single layer film formed from one material, or a composite film or multilayer film formed from one or more materials.

The separator 14 has a thickness of, for example, 10-300 μm, preferably 15-200 μm, more preferably 15-100 μm, still more preferably 20-30 μm.

The separator 14 has a porosity preferably in the range of 30-70%, more preferably in the range of 35-60%. Here, porosity means a volumetric ratio of the void portion in the separator 14 based on the volume of the separator 14.

The outer package 17 is an outer package commonly used in a soft package lithium secondary battery. For example, films of polymers such as polyethylene, polypropylene, polycarbonate, polyamide and the like, or composite films of polymer films and films of metals such as aluminum, copper, nickel and the like may be exemplified. The outer package 17 may be formed into any desired shape.

The electrolyte solution 18 is generally a non-aqueous electrolyte solution comprising a non-aqueous solvent and a lithium salt (electrolyte) dissolved in the non-aqueous solvent.

As the non-aqueous solvent, a non-aqueous solvent known for common use in a secondary battery comprising a non-aqueous electrolyte, for example, cyclic carbonates, chain carbonates, cyclic carboxylates, chain carboxylates, etc, may be used. As the cyclic carbonate, for example, propylene carbonate (PC), ethylene carbonate (EC) and the like may be exemplified. As the chain carbonate, for example, diethyl carbonate (DEC), ethyl methyl carbonate (EMC), dimethyl carbonate (DMC) and the like may be exemplified. As the cyclic carboxylate, for example, γ-butyrolactone (GBL), γ-valerolactone (GVL), α-methyl-γ-butyrolactone, α-bromo-γ-butyrolactone and the like may be exemplified. As the chain carboxylate, for example, methyl acetate, ethyl acetate, methyl propionate, n-propyl propionate (PrPr), ethyl butyrate, butyl acetate, n-propyl acetate, iso-butyl propionate, benzyl acetate and the like may be exemplified. The non-aqueous solvents may be used alone or in a combination of two or more of them.

As the lithium salt (electrolyte), a lithium salt known for common use in a secondary battery comprising a non-aqueous electrolyte may be used. For example, chlorate-containing lithium salts (LiClO₄, LiAlCl₄, LiB₁₀Cl₁₀, etc), fluorate-containing lithium salts (LiPF₆, LiBF₄, LiSbF₆, LiAsF₆, LiCF₃SO₃, LiCF₃CO₂, etc), fluorimide-containing lithium salts (LiN(CF₃SO₂)₂, LiN(CF₃SO₂)(C₄F₉SO₂), LiN(C₂F₅SO₂)₂, etc), lithium halides (LiCl, LiBr, LiI, etc) may be exemplified. These lithium salts may be used alone or in a combination of two or more of them.

The lithium salt in the non-aqueous electrolyte has a concentration of, for example, 0.5-2 mol/L.

The non-aqueous electrolyte may comprise known additives. As such an additive, for example, an additive that can decompose on a negative electrode to form a coating film having high lithium ion conductivity and improve the charge-discharge efficiency of a battery (additive A), an additive that decomposes upon overcharge to form a coating film on an electrode and deactivate a battery (additive B), as well as nitrile additives, phosphazene additives, fluoro-containing additives and the like may be exemplified.

The additive has a content of 10 mass % or less, preferably 7 mass % or less in the non-aqueous electrolyte.

As the additive A, cyclic carbonates having polymeric unsaturated bonds (vinylene group, vinyl group, etc), and cyclic carbonates having fluorine atoms (fluorinated ethylene carbonate (FEC), fluorinated propylene carbonate, etc) may be exemplified.

As the cyclic carbonate having a vinylene group, vinylene carbonates (VCs) having a C1-4 alkyl group and/or a C6-10 aryl group and the like as substituents, such as vinylene carbonate, 4-methyl vinylene carbonate, 4,5-dimethyl vinylene carbonate, 4-ethyl vinylene carbonate, 4-phenyl vinylene carbonate and the like, may be exemplified.

As the cyclic carbonate having a vinyl group, ECs having a vinyl group as a substituent, such as vinyl ethylene carbonate (VEC), divinyl ethylene carbonate and the like, may be exemplified. In addition, among these compounds, those in which a portion of the hydrogen atoms constituting substituents or the cyclic carbonates are replaced by fluorine atoms may also be used as the above additives.

The additive A may be used alone or in a combination of two or more of them.

As the additive B, aromatic compounds having aliphatic rings, aromatic compounds having a plurality of aromatic rings and the like may be exemplified.

As the aliphatic ring, in addition to cyclic alkane rings such as cyclohexane ring and the like, cyclic ethers, cyclic esters and the like may also be exemplified. As the aromatic compound, aromatic compounds having these aliphatic rings as substituents are preferred. As specific examples of the aromatic compound, benzene compounds such as cyclohexyl benzene and the like may be exemplified.

As the aromatic compound having a plurality of aromatic rings, biphenyl, diphenyl ether and the like may be exemplified.

These additives B may be used alone or in a combination of two or more of them.

As the nitrile additive, butyronitrile, valeronitrile, n-heptanenitrile, butanedinitrile, pentanedinitrile, hexanedinitrile, heptanedinitrile, 1,2,3-propane tricarbonitrile, 1,3,5-pentane tricarbonitrile and the like may be exemplified. These nitrile additives may be used alone or in a combination of two or more of them.

As the phosphazene additive, hexamethyl phosphazene, phosphonitrilic chloride trimer, and ethoxypentafluorocyclotriphosphazene may be exemplified. These phosphazene additives may be used alone or in a combination of two or more of them.

As the fluoro-containing additives, fluoroethylene carbonate (FEC), trifluoropropylene carbonate (TFPC), fluorobenzene, 1,1,2,2-tetrafluoroethyl-2,2,3,3-tetrafluoropropyl ether, lithium tetrafluoroborate and the like may be exemplified. These fluoro-containing additives may be used alone or in a combination of two or more of them.

The non-aqueous electrolyte may be liquid. However, it may also be gel or solid.

A liquid non-aqueous electrolyte comprises a non-aqueous solvent and a lithium salt dissolved in the non-aqueous solvent.

A gel non-aqueous electrolyte comprises a liquid non-aqueous electrolyte and a polymeric material holding the non-aqueous electrolyte.

As such a polymeric material, fluororesins such as PVdF, vinylidene fluoride-hexapropylene copolymer and the like; vinyl resins such as polyacrylonitrile, polyvinyl chloride and the like; polyalkylene oxide such as polyethylene oxide and the like; acrylic resins such as polyacrylates and the like may be exemplified.

A solid non-aqueous electrolyte comprises a polymeric solid electrolyte. As the polymeric electrolyte, for example, perfluorosulfonic acid/polytetrafluoroethylene copolymer (H⁺ type), sulfonated polyether sulfone (H⁺ type), aminated polyether sulfone (OH⁻ type) and the like may be exemplified.

The soft package lithium secondary battery 11 according to an embodiment of the present disclosure has been described above with reference to FIG. 5. However, the shape of the battery is not particularly limited. A cylindrical shape, a square shape, a sheet shape and the like may also be employed. Accordingly, the shape of the outer package is not particularly limited either, and depends on the shape of the battery. In addition to a coin shape, it may also be a cylindrical shape, a square shape, a sheet shape or the like.

In addition, when the lithium secondary battery is made into a cylindrical shape, a square shape, a sheet shape or the like, the case of the battery is generally made of a metal. For example, aluminum, aluminum alloys (alloys comprising trace amounts of such metals as manganese, copper, etc), iron, stainless steel and the like may be used. The battery case may be plated by nickel plating or the like as desired.

The method of manufacturing the negative electrode structure for a secondary battery according to the present disclosure is a method used to manufacture the prelithiated negative electrode structure for a secondary battery comprising in order a negative electrode mixture layer comprising a negative electrode active material, a buffer layer and a lithium layer as described above, wherein the method comprises: a process step of forming a negative electrode mixture layer comprising a negative electrode active material, a process step of forming a buffer layer on the negative electrode mixture layer, and a process step of forming a lithium layer on the buffer layer, wherein the buffer layer is allowed to cover the negative electrode mixture layer incompletely in the process step of forming the buffer layer. The negative electrode structure for a secondary battery manufactured according to this manufacturing method has both good battery performances and a sufficiently low thermal runaway risk in good balance, quite useful in a negative electrode for a secondary battery.

Now, an embodiment of the method of manufacturing the negative electrode structure for a secondary battery according to the present disclosure will be described in detail, but the implementation of the method of manufacturing the negative electrode structure for a secondary battery according to the present disclosure is not limited thereto.

First, a negative electrode mixture layer comprising a negative electrode active material is formed. In particular, a negative electrode active material of any of those described above is prepared, and blended with one or more of the binders, conductive agents and/or thickeners described above, and then a dispersing medium is added to form a negative electrode mixture slurry. Subsequently, the negative electrode mixture slurry is coated on a surface of a negative electrode current collector using a method of any of those described above, and dried to form an electrode shape. A negative electrode mixture layer is thus obtained.

Subsequently, a buffer layer is formed on the negative electrode mixture layer. In particular, a buffer layer forming material of any of those described above is prepared, and blended with one or more of the binders described above as desired, and a dispersing medium is added to form a buffer layer slurry. Subsequently, the buffer layer slurry is coated on a surface of the negative electrode mixture layer using a method of any of those described above, and dried to form a desired continuous or discontinuous shape (e.g. island or stripe). A buffer layer is thus obtained.

At this time, it should be noted that the buffer layer shall not cover the negative electrode mixture layer completely. For example, the area ratio of the area of the buffer layer to the area of the negative electrode mixture layer or the lithium layer is allowed to be 5-95%. As such, the negative electrode structure comprising such a buffer layer has both good battery performances and a sufficiently low thermal runaway risk in good balance, quite useful in a negative electrode for a secondary battery.

Then, a lithium layer is formed on the buffer layer. In particular, a lithium layer is formed by vacuum evaporation of lithium on the negative electrode mixture layer incompletely covered with the buffer layer formed as described above, or by rolling/adhering a lithium foil to a surface of the negative electrode mixture layer with the buffer layer formed thereon. As such, the prelithiated negative electrode structure for a secondary battery according to the present disclosure is obtained.

If it's desired to use the prelithiated negative electrode structure for a secondary battery according to the present disclosure to manufacture a secondary battery, a manufacturing method commonly used in the art may be employed. For instance, taking the soft package lithium secondary battery 11 shown in FIG. 5 as an example, a positive electrode 13 may be arranged on a positive electrode current collector 12; a separator 14 may be laminated on the positive electrode 13; and then the negative electrode structure (negative electrode 16) for a secondary battery according to the present disclosure may be arranged on a negative electrode current collector 15. Subsequently, the positive electrode 13 with the separator 14 laminated thereon is combined with the negative electrode 16, and loaded into an outer package 17 of the battery. The outer package 17 is then filled with an electrolyte solution 18. Electrode tabs are fixed to the outer package 17 which is then sealed.

As a secondary battery, a soft package lithium secondary battery is illustrated above. However, lithium secondary batteries of various shapes such as a cylindrical lithium secondary battery, a square lithium secondary battery and the like may also be used. In addition, those electrode structures commonly used in the art, such as the structures with a plurality of positive electrodes, a plurality of negative electrodes and a plurality of separators laminated, the structures with positive electrodes, negative electrodes and separators rolled, etc, may also be used.

As a secondary battery using the negative electrode structure for a secondary battery according to the present disclosure has both good battery performances and a sufficiently low thermal runaway risk, it can be used reliably as a power source for various electric and electronic devices driven by electricity.

As specific examples of such electrical and electronic devices, mention may be made to televisions, display devices such as monitors, lighting devices, table or notebook computers, word processors, image reproduction devices for reproducing static or dynamic images stored in record media such as DVD (Digital Versatile Disc) and the like, portable CD players, radios, tape recorders, headphone audio systems, audio systems, table clocks, wall clocks, cordless telephone slaves, walkie-talkies, portable wireless devices, mobile phones, vehicle phones, portable game consoles, calculators, portable information terminals, electronic notebooks, ebook readers, electronic translators, audio input units, video cameras, digital static cameras, electric razors, high frequency heating devices such as microwave furnaces, electric cookers, washing machines, cleaners, water heaters, electric fans, electric hair driers, air conditioning devices such as air conditioners, humidifiers and dehumidifiers, dish washers, dish driers, clothes driers, bed warmers, refrigerators, freezers, refrigerator-freezers, freezers for preservation of nucleic acids, flashlights, tools such as chain saws, smoke detectors, medical devices such as dialysis devices, etc. In addition, industrial devices may be further exemplified, such as guiding lights, annunciators, conveying belts, escalators, elevators, industrial robots, electric power storage systems, electric power storage devices for electric power homogenization or for smart power grids. Furthermore, moving bodies driven by electromotors using power from lithium secondary batteries are also included in the scope of the electric and electronic devices. As examples of the above moving bodies, mention may be made to electric vehicles (EV), hybrid electric vehicles (HEV) having both internal combustion engines and electromotors, plug-in hybrid electric vehicles (PHEV), crawler vehicles with crawlers in place of the wheels of the above vehicles, electric bicycles including electric power assisted bicycles, motorcycles, electrically propelled wheelchairs, golf carts, small or large boats, submarines, helicopters, planes, rockets, man-made satellites, space probes, planet probes, spacecrafts, etc.

Now, the present disclosure will be illustrated specifically with reference to the following Examples and Comparative Examples, but the present disclosure is not limited by the following Examples.

Additionally, unless otherwise specified, the materials used in the Examples were all purchased from Murata Manufacturing Co., Ltd.

### Example 1

Preparation of Negative Electrode Structure for Secondary Battery

(1) Preparation of Negative Electrode Mixture Layer

A negative electrode mixture slurry comprising natural graphite as a negative electrode active material was coated on a copper foil current collector, and dried to obtain a negative electrode mixture layer.

(2) Preparation of Buffer Layer

A buffer layer slurry comprising water-borne PVdF (a water-borne PVDF latex from Arkema Co.) as a buffer layer forming material was coated on the negative electrode mixture layer obtained in the preceding process step, followed by drying and cold pressing the resulting coating film to obtain a buffer layer arranged on the negative electrode mixture layer. Here, the coating conditions were controlled to form the buffer layer on the negative electrode mixture layer in an island shape, and the area ratio of the area of the buffer layer to the area of the negative electrode mixture layer was 5%.

In addition, at the moment, the negative electrode mixture layer with the buffer layer as thus prepared was subjected to porosity measurement by mercury intrusion porosimetry and electrolyte retention test. The results are shown in Table 1.

(3) In an inert atmosphere, a lithium foil having the same shape as the negative electrode mixture layer was placed uniformly and flatly on a surface of the buffer layer obtained in the preceding process step, and cold pressed to obtain a metal lithium layer arranged on the buffer layer. Thus, a negative electrode structure comprising the negative electrode mixture layer, the buffer layer and the lithium layer in order was formed.

In addition, at the moment, the negative electrode structure as thus formed was tested for heat generation using an IR thermodetector. The results are shown in Table 1. The results shown in Table 1, represented by percentages, are relative values calculated by assuming the heat generated by the negative electrode structure of Comparative Example 1 having no buffer layer to be 100%.

Preparation of Secondary Battery

A positive electrode mixture slurry comprising lithium cobalt oxide as a positive electrode active material was coated on an aluminum foil current collector, and dried to obtain a positive electrode structure. The positive electrode structure, the above negative electrode structure and a separator formed from a microporous polypropylene film were rolled into a roll core, and loaded into a polyethylene/aluminum composite film case. A LiPF₆ electrolyte solution was filled in the case, and a formation process was conducted. After packaging, a soft package secondary battery product was obtained.

The soft package secondary battery product prepared as described above was evaluated for battery performance (rate performance), safety, and mass productivity of the prelithiation process. The evaluation methods are described as follows.

The soft package secondary battery product prepared as described above was charged at a charge rate of 2 C, and then discharged at a discharge rate of 1 C. The rate performance of the soft package secondary battery product was calculated according to (actual discharge capacity/actual charge capacity). The result is shown in Table 1. The results shown in Table 1, represented by percentages, are relative values calculated by assuming the rate performance of the negative electrode structure of Comparative Example 1 having no buffer layer to be 100%.

(1) The soft package secondary battery product prepared as described above was placed in a thermostat at 150° C. for 10 minutes. If the product did not get on fire and did not explode during its stay in the thermostat, it would be regarded to have high safety.

(2) The soft package secondary battery product prepared as described above was overcharged at a constant current of 3 C until the battery voltage arrived at 10 V, and then changed to be charged at a constant voltage. In this case, if the product still did not get on fire and did not explode when the charge time reached 90 minutes, it would be regarded to have high safety.

(3) A needle of 3 mm in diameter was used to penetrate the soft package secondary battery product prepared as described above. In this case, if the product did not explode, it would be regarded to have high safety.

(4) After fully charged, the soft package secondary battery product prepared as described above was placed on a flat plate, and the battery was compressed with a planar face of a steel rod of 32 mm in diameter under a compression force of 13±1 KN applied by an oil hydraulic cylinder. If the product did not get on fire and did not explode when the compression force reached its maximum, the product would be regarded to have high safety.

The evaluation results of the above four safety indicators were considered as a whole. If all the evaluation results were “high”, the battery safety of the soft package secondary battery product would be evaluated as “high”. The results are shown in Table 1.

All the results of the above evaluations were taken into consideration. If the example soft package secondary battery product was comparable with the soft package secondary battery product of Comparative Example 1 described hereafter having no buffer layer in terms of porosity and electrolyte retention of the negative electrode as well as the rate performance of the soft package secondary battery product, while heat generation was inhibited significantly and safety was improved significantly, the mass productivity of the prelithiation process would be regarded high. Otherwise, if any of the above items did not meet the above requirements, the mass productivity of the prelithiation process would be regarded low. The results are shown in Table 1.

### Example 2

Except that the shape of the buffer layer was changed into stripe as compared with Example 1, a negative electrode structure for a secondary battery was prepared the same way as in Example 1, and the resulting negative electrode structure for a secondary battery was also used to prepare a soft package secondary battery product. The battery performance (rate performance), safety and mass productivity of the prelithiation process were evaluated the same way. The results are shown in Table 1.

### Comparative Example 1

Except that no buffer layer was formed (i.e. the area ratio of the buffer layer was 0%), a negative electrode structure for a secondary battery was prepared the same way as in Example 1, and the resulting negative electrode structure for a secondary battery was also used to prepare a soft package secondary battery product. The battery performance (rate performance), safety and mass productivity of the prelithiation process were evaluated the same way. The results are shown in Table 1.

### Comparative Example 2

Except that the area ratio of the area of the buffer layer to the area of the negative electrode mixture layer was changed into 100% (i.e. the buffer layer covered the negative electrode mixture layer completely) as compared with Example 1, a negative electrode structure for a secondary battery was prepared the same way as in Example 1, and the resulting negative electrode structure for a secondary battery was also used to prepare a soft package secondary battery product. The battery performance (rate performance), safety and mass productivity of the prelithiation process were evaluated the same way. The results are shown in Table 1.

TABLE 1

| | | | | | | | Mass productivity |
|---|---|---|---|---|---|---|---|
| Example | Buffer Layer | Electrode | Electrolyte | Heat | Rate | Battery | of Prelithiation |
| No. | Area | Porosity | Retention | Generated | Performance | Safety | Process |
| Ex. 1 | Island buffer | 22% | 1.9 g/Ah | 57% | 97% | High | High |
| | layer (5%) | | | | | | |
| Ex. 2 | Stripe buffer | 21% | 1.9 g/Ah | 55% | 96% | High | High |
| | layer (5%) | | | | | | |
| Comp. | No buffer | 23% | 2.0 g/Ah | 100% | 100% | Low | Low |
| Ex. 1 | layer | | | | | | |
| Comp. | 100% buffer | 15% | 1.0 g/Ah | 18% | 40% | High | Low |
| Ex. 2 | layer | | | | | | |

As known from Table 1, as compared with the case where a conventional negative electrode structure with no buffer layer formed therein was used (Comparative Example 1), the soft package secondary battery products using the negative electrode structures of Examples 1 and 2 where the buffer layers covered the negative electrode mixture layers incompletely (i.e. the area ratio of the buffer layer was 5%) provided substantially the same levels of negative electrode porosity and electrolyte retention as well as rate performance, while the heat generated was decreased to 57% and 55% respectively, and the battery safety was improved significantly. Hence, the mass productivity of the prelithiation process was also relatively high. The batteries prepared in Examples 1 and 2 were secondary batteries having both good battery performances and a sufficiently low thermal runaway risk which were well balanced.

In addition, as compared with Comparative Example 1, the soft package secondary battery product using the negative electrode structure of Comparative Example 2 where the area ratio of the buffer layer was 100% generated much less heat (18%), and exhibited very high battery safety, but the negative electrode porosity and the electrolyte retention as well as rate performance of the soft package secondary battery product were decreased greatly at the same time. Hence, the mass productivity of the prelithiation process was so low that its application was totally impractical.

### Examples 3-5

Except that the area ratio of the area of the buffer layer to the area of the negative electrode mixture layer was changed into 15%, 50%, 80% respectively as compared with Example 2, negative electrode structures for secondary batteries were prepared the same way as in Example 2, and the resulting negative electrode structures for secondary batteries were also used to prepare soft package secondary battery products. The rate performance and heat generation of the batteries were evaluated the same way. The results are summarized in Table 2.

### Examples 6-9

Except that the buffer layer forming material was changed into boehmite type Al₂O₃ as compared with Examples 2-5, negative electrode structures for secondary batteries were prepared the same way as in Examples 2-5, and the resulting negative electrode structures for secondary batteries were also used to prepare soft package secondary battery products. The rate performance and heat generation of the batteries were evaluated the same way. The results are summarized in Table 2.

### Comparative Example 3

Except that the buffer layer forming material was changed into boehmite type Al₂O₃ as compared with Comparative Example 2, a negative electrode structure for a secondary battery was prepared the same way as in Comparative Example 2, and the resulting negative electrode structure for a secondary battery was also used to prepare a soft package secondary battery product. The rate performance and heat generation of the batteries were evaluated the same way. The results are summarized in Table 2.

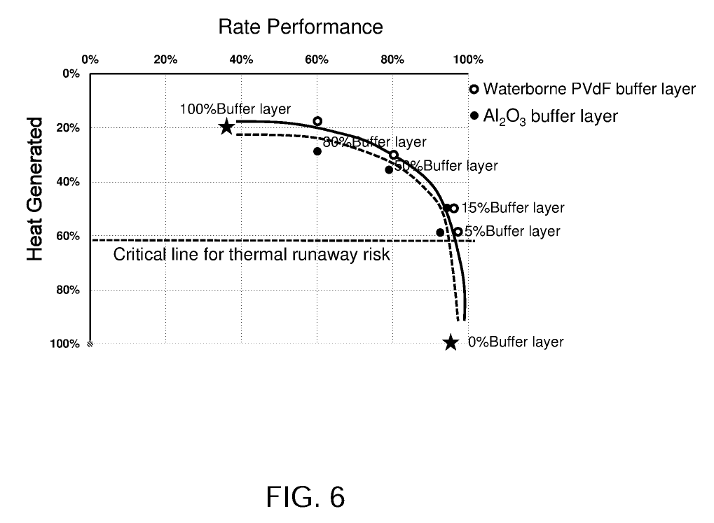

In addition, to facilitate comparison, the results of the above Comparative Examples 1 and 2 are also summarized in Table 2. FIG. 6 is a graph plotted based on the experimental results in Table 2.

TABLE 2

| | Area | | | |
|---|---|---|---|---|
| | Ratio of | Buffer Layer | | |
| Example | Buffer | Forming | Heat | Rate |
| No. | Layer | Material | Generated | performance |
| Ex. 2 | 5% | Water-borne PVdF | 57% | 96% |
| Ex. 3 | 15% | Water-borne PVdF | 51% | 95% |
| Ex. 4 | 50% | Water-borne PVdF | 35% | 80% |
| Ex. 5 | 80% | Water-borne PVdF | 18% | 60% |
| Ex. 6 | 5% | Al₂O₃(boehmite type) | 58% | 91% |
| Ex. 7 | 15% | Al₂O₃(boehmite type) | 50% | 93% |
| Ex. 8 | 50% | Al₂O₃(boehmite type) | 37% | 79% |
| Ex. 9 | 80% | Al₂O₃(boehmite type) | 29% | 60% |
| Comp. Ex. 1 | 0% | — | 100% | 100% |
| Comp. Ex. 2 | 100% | Water-borne PVdF | 18% | 40% |
| Comp. Ex. 3 | 100% | Al₂O₃(boehmite type) | 22% | 38% |

As known from Table 2 and FIG. 6, as compared with the case where a conventional negative electrode structure with no buffer layer formed therein was used, the soft package secondary battery products using buffer layers which cover negative electrode mixture layers incompletely (i.e. the area ratio of the buffer layer was neither 0% nor 100%) provided substantially the same level of rate performance, while the heat generated was decreased significantly, and the battery safety was improved significantly. Hence, the mass productivity of the prelithiation process was also relatively high. The batteries prepared in the Examples were secondary batteries having both good battery performances and a sufficiently low thermal runaway risk which were well balanced.

Additionally, as shown by FIG. 6, the curves of the results from those Examples where water-borne PVdF was used as a buffer layer forming material are closer to the upper right of the figure than the curves of the results from those Examples where boehmite type Al₂O₃ was used as a buffer layer forming material. In other words, although the object of the present disclosure can be well achieved in both cases, comparatively speaking, better effect in inhibiting heat generation and better rate performance can be obtained in the case where water-borne PVdF is used as a buffer layer forming material. Without being limited by any theory, it's postulated that the reason lies in the difference in the buffer layer shape (area), the difference in the buffer layer material, as well as the difference in the buffer layer porosity/pore size and the difference in the ion/electron conductivity of the buffer layer resulting from the difference in the buffer layer material, and other factors. In particular, among the above factors, the buffer layer shape (area) has a linear relationship with the generated heat and the rate performance, and the porosity/pore size and ion/electron conductivity of the buffer layer have an influence on the reaction rates for forming LiCx, LiSix, LiMex and the like. In accordance with Arrhenius equation, these factors each have an exponential relationship with the generated heat, and the reaction rates for forming LiCx, LiSix, LiMex and the like. As can thus be seen, the curves can be shifted by adjusting these factors to achieve such technical effects as minimizing the generated heat and maximizing the rate performance.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A negative electrode structure for a secondary battery comprising:
a negative electrode mixture layer, a buffer layer and a lithium layer,
wherein the negative electrode mixture layer includes a negative electrode active material, and
wherein the buffer layer is configured to partially cover the negative electrode mixture layer.

2. The negative electrode structure according to claim 1,
wherein
an area ratio of an area of the buffer layer to an area of the negative electrode mixture layer or the lithium layer is from 5% to 95%.

3. The negative electrode structure according to claim 1, wherein a shape of the buffer layer includes an island shape or a stripe shape.

4. The negative electrode structure according to claim 1, wherein the buffer layer includes at least one material selected from the group consisting of inorganic ceramic materials, solid electrolyte micropowders, water-borne PVdF, flame resistant conductive polymers, gel electrolytes, electrolyte soluble organics, carbon nanomaterials, and combinations thereof,
wherein the inorganic ceramic materials include at least one of boehmite particles, alumina powder, AlF₃ powder, MgO, magnesium hydroxide, rutile type TiOx, and anatase type TiOx;
wherein the solid electrolyte micropowders include at least one of solid electrolyte micropowders of perovskite type, NASICON type, LISICON type, and garnet type;
wherein the flame resistant conductive polymers include at least one of polyaniline, polypyrrole, polythiophene, and the gel electrolytes include PVdF-HEP;
wherein the electrolyte soluble organics include at least one of polysiloxane, and ethylene carbonate, and
wherein the carbon nanomaterials include at least one of soft carbon, hard carbon, acetylene black, Ketjen black, graphite black, and carbon nanotubes.

5. The negative electrode structure according to claim 1, wherein the buffer has a thickness from 0.1 μm to 5 μm.

6. The negative electrode structure according to claim 1, wherein the negative electrode structure is a prelithiated negative electrode structure.

7. The negative electrode structure according to claim 1, wherein the negative electrode active material includes at least one of graphite, Si based materials, and Sn based alloys.

8. A method of manufacturing a negative electrode structure for a secondary battery, wherein the negative electrode structure includes a negative electrode mixture layer including a negative electrode active material, a buffer layer and a lithium layer;
wherein the manufacturing method comprises:
a process step of forming a negative electrode mixture layer including a negative electrode active material;
a process step of forming a buffer layer on the negative electrode mixture layer; and
a process step of forming a lithium layer on the buffer layer, and
wherein
in the process step of forming the buffer layer, the buffer layer is configured to partially cover the negative electrode mixture layer.

9. The method according to claim 8, wherein
an area ratio of an area of the buffer layer to an area of the negative electrode mixture layer or the lithium layer is from 5% to 95%.

10. The method according to claim 8, further comprising forming the buffer layer into an island shape or a stripe shape.

11. The method according to claim 8, wherein the buffer layer includes at least one material selected from the group consisting of inorganic ceramic materials, solid electrolyte micropowders, water-borne PVdF, flame resistant conductive polymers, gel electrolytes, electrolyte soluble organics, carbon nanomaterials, and combinations thereof,
wherein the inorganic ceramic materials include at least one of boehmite particles, alumina powder, AlF₃ powder, MgO, magnesium hydroxide, rutile type TiOx, and anatase type TiOx;
wherein the solid electrolyte micropowders include at least one of solid electrolyte micropowders of perovskite type, NASICON type, LISICON type, and garnet type;
wherein the flame resistant conductive polymers include at least one of polyaniline, polypyrrole, polythiophene, and the gel electrolytes include PVdF-HEP;
wherein the electrolyte soluble organics include at least one of polysiloxane, and ethylene carbonate, and
wherein the carbon nanomaterials include at least one of soft carbon, hard carbon, acetylene black, Ketjen black, graphite black, and carbon nanotubes.

12. The method according to claim 8, wherein the negative electrode structure is a prelithiated negative electrode structure.

13. The method according to claim 8, wherein the negative electrode active material includes at least one of graphite, Si based materials, and Sn based alloys.

14. The method according to claim 8, wherein the buffer layer is formed by a coating method including at least one of spin coating, wire-bar coating, slot die coating, gravure coating, and screen printing.

15. A secondary battery, comprising:
a positive electrode,
a negative electrode,
a separator and an electrolyte,
wherein the negative electrode includes a negative electrode structure including a negative electrode mixture layer, a buffer layer and a lithium layer,
wherein the negative electrode mixture layer includes a negative electrode active material, and wherein the buffer layer is configured to partially cover the negative electrode mixture layer.

16. The secondary battery according to claim 15,
wherein an area ratio of an area of the buffer layer to an area of the negative electrode mixture layer or the lithium layer is from 5% to 95%.

17. The secondary battery according to claim 15,
wherein a shape of the buffer layer includes an island shape or a stripe shape.

18. The secondary battery according to claim 15, wherein the buffer layer includes at least one material selected from the group consisting of inorganic ceramic materials, solid electrolyte micropowders, water-borne PVdF, flame resistant conductive polymers, gel electrolytes, electrolyte soluble organics, carbon nanomaterials, and combinations thereof,
wherein the inorganic ceramic materials include at least one of boehmite particles, alumina powder, AlF₃ powder, MgO, magnesium hydroxide, rutile type TiOx, and anatase type TiOx;
wherein the solid electrolyte micropowders include at least one of solid electrolyte micropowders of perovskite type, NASICON type, LISICON type, and garnet type;
wherein the flame resistant conductive polymers include at least one of polyaniline, polypyrrole, polythiophene, and the gel electrolytes include PVdF-HEP;
wherein the electrolyte soluble organics include at least one of polysiloxane, and ethylene carbonate, and
wherein the carbon nanomaterials include at least one of soft carbon, hard carbon, acetylene black, Ketjen black, graphite black, and carbon nanotubes.

19. The secondary battery according to claim 15, wherein the buffer has a thickness from 0.1 μm to 5 μm.
